(19) United States
(12) Patent Application Publication
(10) Pub. No.: US 2018/0181239 A1
(43) Pub. Date: Jun. 28, 2018

(54) LIQUID CRYSTAL DISPLAY DEVICE WITH TOUCH SENSOR AND METHOD FOR DRIVING THE SAME

(71) Applicant: Shenzhen China Star Optoelectronics Technology Co., Ltd., Shenzhen, Guangdong (CN)

(72) Inventor: Sikun Hao, Shenzhen, Guangdong (CN)

(73) Assignee: Shenzhen China Star Optoelectronics Technology Co., Ltd., Shenzhen, Guangdong (CN)

(21) Appl. No.: 15/323,815

(22) PCT Filed: Oct. 12, 2016
(86) PCT No.: PCT/CN2016/101892

§ 371 Date: Jan. 4, 2017

(30) Foreign Application Priority Data
Aug. 31, 2016 (CN) 201610792710.1

(51) Int. Cl. G06F 3/041; G06F 3/044; G09G 3/36; G02F 1/1333; G02F 1/1362; G02F 1/1335

(52) U.S. Cl. CPC G06F 3/0412; G06F 3/044; G06F 3/0416; G02F 2201/121; G02F 1/13338; G02F 1/136286; G02F 1/133514; G09G 3/3677

(57) ABSTRACT

Disclosed is a liquid crystal display device having a touch sensor and a method of driving the same, which relates to the technical field of liquid crystal display. The liquid crystal display device having a touch sensor is provided to solve the problem that a penetration rate of a display device in the prior art is decreased significantly. A touch control function is added in a pixel of the liquid crystal display device and the touch control function is achieved through a touch lead. Common electrodes covering data lines between blue sub-pixels and red sub-pixels of two adjacent pixel units are set as touch leads. The touch leads serve as touch lines during a touch scanning stage and serve as the common electrodes during a non-touch scanning stage. Moreover, the present disclosure is mainly applied to a liquid crystal flat display panel.

### CROSS-REFERENCE TO RELATED APPLICATIONS

The present application claims the priority of Chinese patent application CN201610792710.1, entitled “Liquid crystal display device with touch senor and method for driving the same” and filed on Aug. 31, 2016, the entirety of which is incorporated herein by reference.

### TECHNICAL FIELD

The present disclosure relates to the technical field of liquid crystal display, and in particular, to a liquid crystal display device with touch control function.

### TECHNICAL BACKGROUND

A liquid crystal display (LCD) is the most popular flat panel display so far and has become a display widely applied to various electronic equipments, such as mobile phones, personal digital assistants (PDAs), digital cameras and computer screens or screens of laptop for its high-resolution and color screen. With the development of the liquid crystal display technology, people put forward higher requirements on display quality, design and man-machine interface and so on of liquid crystal display. Touch control technology has become a hot spot for technical development in this field due to its convenient operation, high integration and other characteristics. An existing thin-film transistor (TFT) liquid crystal display mainly includes two glass substrates and a liquid crystal layer, wherein a surface of an upper glass substrate is provided with a color filter, and a lower glass substrate is provided on a side thereof with TFTs and pixel electrodes. Every pixel comprises three liquid crystal cells, and a red/green/blue filter is arranged before each of the liquid crystal cells respectively. In this way, different colors can be displayed on the screen by passing lights through different cells.

People are familiar with the touch control technology. ATMs of banks and computers in halls of many hospitals, libraries and other places are mostly provided with touch screens. Screens of many mobile phones, MP3 and digital cameras also support touch function. These existing touch screens use single-point touch technology and multi-touch technology. Single-point touch technology means identification and support of touch and click by one finger each time, and multi-touch technology can decompose a task into two aspects: to collect the signals of multiple points at the same time, and to judge the significance of each of the signals, i.e., to conduct the so-called gesture identification, thereby achieving the identification of clicks and touch by five fingers of a user on the screen at the same time.

To make a touch display thinner and lighter, more and more researches are becoming focused on integration of a touch panel and a liquid crystal display panel, and the In-Cell touch control technology of embedding a touch panel into a liquid crystal panel has received people's concern. In-Cell touch control technology includes self-capacitive touch control and mutual capacitive touch control.

In a self-capacitive touch control method, a transparent conducting layer serving as a common electrode (VCOM) on an array substrate is divided into a plurality of squares as touch sensor units, and the touch sensors are interconnected through via holes in presence of one end of a special metal wire; the other end of the special metal wire is connected with a drive integrated circuit. When a finger touches the touch display panel, values of the touch sensor units at corresponding positions fluctuate, and a drive integrated circuit can thus confirm a position of a touch point in accordance with the fluctuation of the capacitance detected. In this way, the function of touch control is achieved.

In a mutual capacitive touch control method, transverse drive electrode (Tx) wires are provided on an array substrate, and longitudinal sensing electrode (Rx) wires are provided on a color filter substrate. The Tx wires emit excitation signals sequentially, and all the Rx wires receive the signals at the same time, by means of which the capacitance of a 2D plane of the whole touch display panel is acquired. Then, a position of a touch point can be calculated in accordance with variation of the capacitance, whereby the function of touch control can be achieved.

To sum up, in an existing self-capacitive touch display panel, a touch lead connecting with a touch sensor unit is made of a particular metal and it shall be sheltered by increasing a width of a black matrix, which often leads to great decrease of aperture ratio and transmittance of pixels and further causes penetration rate of the display device to be significantly reduced.

### SUMMARY OF THE INVENTION

The present application provides a liquid crystal display with a touch senor and a method for driving the same in allusion to the above-mentioned problems in the prior art.

The liquid crystal display having a touch sensor in the present disclosure takes data lines covering pixels as touch leads.

The above-mentioned liquid crystal display having the touch sensor is characterized in that the liquid crystal display device comprises an array substrate and a color filter substrate which are arranged oppositely, wherein the array substrate comprises multiple pixel units arranged in an array, and each pixel unit comprises a red sub-pixel, a green sub-pixel and a blue sub-pixel; a common electrodes covering data lines between the blue sub-pixels and the red sub-pixels of two adjacent pixel units are set as the touch leads.

The above-mentioned display crystal display having the touch sensor is characterized in that the touch leads serve as touch lines in a touch scanning stage and serve as the common electrodes in a non-touch scanning stage.

The above-mentioned display crystal display having the touch sensor is characterized in that the common electrodes of two adjacent rows of pixels that are subjected to multiplexing as the touch leads are interconnected.

The above-mentioned display crystal display having the touch sensor is characterized in that the common electrodes subjected to multiplexing as the touch leads are wider than the rest common electrodes.

The above-mentioned display crystal display having the touch sensor is characterized in that the common electrodes are presented as strips.

The above-mentioned display crystal display having the touch sensor is characterized in that the array substrate comprises multiple data lines arranged in parallel; the touch leads and the data lines are arranged in a same layer in insulated way; and each touch electrode is corresponding to at least one touch lead.

A method of driving a display crystal display having a touch sensor comprises the following two stages.

In a touch scanning stage, a touch drive signal is loaded to a touch electrode through a touch lead; a sensing signal is output from the touch electrode; the touch electrode is connected with a touch signal detection module which confirms a touch position in accordance with the sensing signal output by the touch electrode.

In a non-touch scanning stage, a common electrode signal is loaded to the touch electrode through the touch lead to achieve liquid crystal display.

The present disclosure has the following advantages. According to the display crystal display having the touch sensor and the method of driving the same provided by the present disclosure, the touch leads are added in the blue sub-pixels. The touch leads serve as the touch lines during the touch scanning stage. In the touch scanning stage, the touch drive signal is loaded to the touch electrode through the touch lead; the sensing signals are output by the touch electrode; the touch electrode is connected with the touch signal detection module; the touch position is confirmed by the touch signal detection module in accordance with the sensing signal output by the touch electrode. The touch leads serve as the common electrodes during the rest of the time, namely the display stage. In the display stage, the common electrode signal is loaded to the touch electrode. Moreover, by providing the touch leads in the blue sub-pixels, the pixels are enabled to have the function of touch control and meanwhile significant decrease of the penetration rate of the display is avoided.

The above-mentioned technical features can be combined with one another in various ways or be substituted by equivalent technical features as long as the objective of the present disclosure can be reached.

### BRIEF DESCRIPTION OF THE DRAWINGS

The following further explains the present disclosure in connection with the embodiments and drawings, wherein:

FIG. 1 shows a sub-pixel structure in the prior art, wherein 1-1 indicates a data line; 1-2 indicates an electrode brake line; 1-3 indicates a common electrode line; 1-4 indicates a thin film transistor; and 1-5 indicates a pixel electrode;

FIG. 2 shows a pixel structure with the sub-pixel structure in the FIG. 1, wherein R indicates a red color resistor; G indicates a green color resistor; and B indicates a blue color resistor;

FIG. 3 shows a structural diagram of a GE layer of a pixel with the pixel structure in the FIG. 2;

FIG. 4 shows a structural diagram of an AS layer of the pixel with the pixel structure in the FIG. 2;

FIG. 5 shows a structural diagram of an SE layer of the pixel with the pixel structure in the FIG. 2;

FIG. 6 shows a structural diagram of a VIA layer of the pixel with the pixel structure in the FIG. 2;

FIG. 7 shows a structural diagram of a PE layer of the pixel with the pixel structure in the FIG. 2;

FIG. 8 shows a structure of the sub-pixel in the present disclosure, wherein 1-1 indicates a data line; 1-2 indicates an electrode brake line; 1-3 indicates a common electrode line; 1-4 indicates a thin film transistor; and 1-5 indicates a pixel electrode;

FIG. 9 shows a structural diagram of a GE layer of a pixel with the pixel structure in the FIG. 8;

FIG. 10 shows a structural diagram of an AS layer of the pixel with the pixel structure in the FIG. 8;

FIG. 11 shows a structural diagram of an SE layer of the pixel with the pixel structure in the FIG. 8;

FIG. 12 shows a structural diagram of a VIA layer of the pixel with the pixel structure in the FIG. 8;

FIG. 13 shows a structural diagram of a PE layer of the pixel with the pixel structure in the FIG. 8;

FIG. 14 shows a complete structural diagram of a pixel on the basis of FIG. 1 and FIG. 8, wherein a red color resistor sub-pixel and a green color resistor sub-pixel are composed of the sub-pixels shown in FIG. 1; and a blue color resistor sub-pixel is composed of the sub-pixels shown in FIG. 8;

FIG. 15 shows a schematic diagram of a plane structure of a self-capacitive touch display panel of the prior art;

FIG. 16 shows a profile schematic diagram of the self-capacitive touch display panel in FIG. 15 along an AA1 direction;

In the Figures, identical parts are marked by identical reference signs, and the Figures are not drawn to scale.

### DETAILED DESCRIPTION OF THE EMBODIMENTS

The present disclosure can be understood more clearly in detail by combining with the drawings and detailed description of the embodiments in the present disclosure. However, the embodiments are described here in the present disclosure only for explanation rather than restricting the present disclosure in any way. Anyone skilled in the art can realize any potential forms changed on the basis of present disclosure, and these shall be subject to the scope of the present disclosure. Moreover, the following further explains the present disclosure in connection with the accompanying drawings.

The embodiments of the present disclosure provide a liquid crystal display device having a touch sensor and a method of driving the same, to improve a transmittance of a touch display panel.

The present disclosure is implemented on the basis of following considerations.

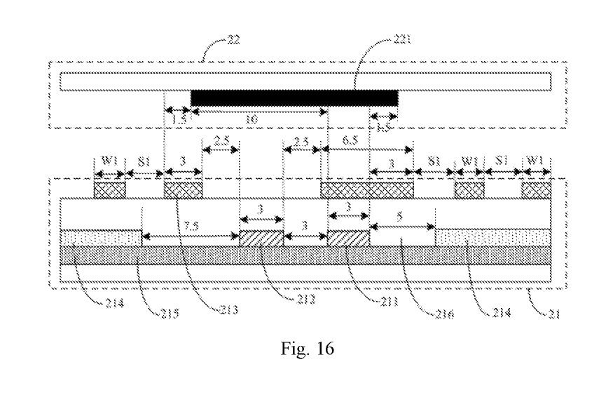

To solve the problem that a pixel has a low transmittance, the most direct method is to reduce a width of a black matrix. However, for the structure of a touch display panel in the prior art, a simple decrease of width of the black matrix may cause exposure of a tangled deflection area of liquid crystals. As shown in FIG. 16, an area between a common electrode 213 and a Tx lead 212 may be exposed if a left width of a black matrix 221 is decreased simply; and deflection of liquid crystals within the exposed area may be disturbed because these liquid crystals are located at an edge of an electric field formed by a pixel electrode 214 and the common electrode 213. In this case, the display effect of the whole panel may be affected. Moreover, as a technical means of solving the above problem that the aperture ratio and the transmittance of pixels are reduced, it is still required to meet the requirement of not leading to decrease of luminous efficacy at the same time.

The following further explains the present disclosure in detail in connection with the accompanying drawings and embodiments in order to make the purpose, the technical scheme and the advantages of the present disclosure clearer. It should be understood that the specific embodiments described here is used to explain the present disclosure only rather than restrict the present disclosure. The following further explains the present disclosure in detail in connection with the accompanying drawings.

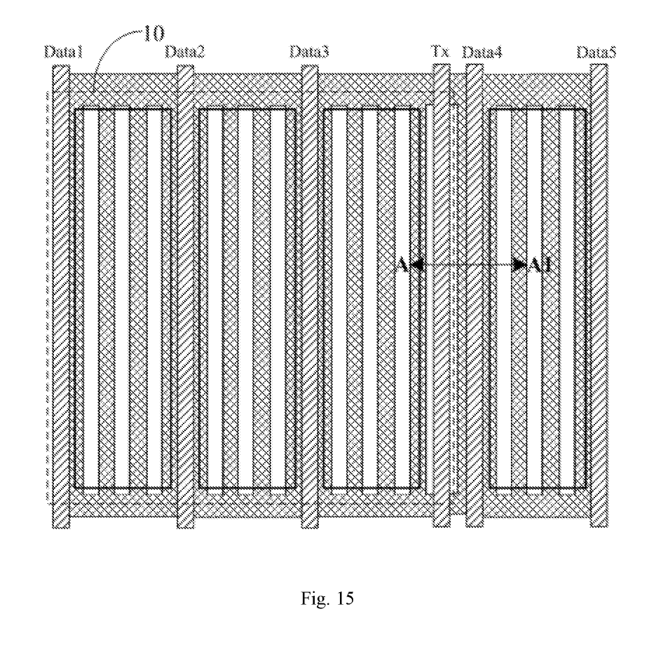

A plane structure of a self-capacitive touch display panel in the prior art is shown in FIG. 15, and a sectional diagram along AA1 direction in the figure is shown in FIG. 16. The self-capacitive touch display panel comprises an array substrate 21 and a color filter substrate 22 which are arranged oppositely. The array substrate 21 is manufactured through six mask processes during which a gate, a semiconductor active layer, a pixel electrode, a source, a drain, a passivation layer and a common electrode are formed sequentially on a base substrate. The common electrode is divided into multiple squares which are subjected to multiplexing as touch electrodes. Each touch electrode is connected with a touch electrode (Tx) lead through a via hole passing through the passivation layer. The Tx lead is finally connected to a drive integrated circuit integrating a display function and a touch control function.

As shown in FIG. 15, the array substrate comprises a plurality of pixel units 10 which is arranged in an array. Each pixel unit 10 comprises three sub-pixel units that are corresponding to a red (R) color filter, a green (G) color filter and a blue (B) color filter of the color filter substrate. Each pixel unit 10 comprises three data lines and one Tx lead sharing an identical metal layer. A double-source structure is formed by the Tx lead in one pixel unit and the data lines of a next pixel unit. Specifically, the pixel unit 10 in the figure comprises a Data 1, a Data 2, a Data 3 and one Tx lead, and a double-source structure is formed by the Tx lead and a Data 4 in the next pixel unit.

As shown in FIG. 16, the widths of all parts which are usually set up are given in FIG. 16 in order to describe the width of the black matrix 221 on corresponding color filter substrate 22 at the position of double-source structure of the array substrate 21 intuitionally. As can be seen from the figure, the data line 211 has a width of 3 μm; the Tx lead 212 has a width of 3μm; and the data line 211 is 3 μm far from the Tx lead 212. To ensure that the design of an aperture area of the black matrix 221 is consistent with three sub-pixel units, one common electrode shall be designed on left side of the Tx lead 212, and the Tx lead 212 shall be 2.5 μm far from the common electrode 213 on the left side thereof so that the Tx lead would not overlap the common electrode in presence of the worst process fluctuation. The common electrode 213 on left side of the Tx lead 212 has a width of 3 μm. A right edge of the black matrix 221 is 1.5 μm far from a right edge of the data line 211. A left edge of the black matrix 221 is 4 μm far from a left edge of the Tx lead 212. The Tx lead 212 is 7.5 μm far from the pixel electrode 214, and the data line 211 is 5 μm far from the pixel electrode 214. A width W1 of the common electrode and a distance S1 between two adjacent common electrodes can be set with different values in accordance with actual production. Moreover, as can be seen from the figure, the black matrix 221 has a width of 14.5 μm. Reference number 215 and reference number 216 in the figure each indicate an insulating layer.

In a double-source structure of the prior art, the Tx lead shares the identical metal layer with the data line, and therefore the introduction of the Tx lead can result in reduction of the aperture rate of the pixel, thereby significantly reducing the transmittance of the pixel.

The prior art also provides a self-capacitive touch display panel, and the array substrate thereof comprises a common electrode provided on a base substrate. The common electrode is subjected to multiplexing as multiple touch electrodes, each of which is connected with a touch electrode lead electrically. The touch electrode lead is subjected to multiplexing as common electrode lines. The touch electrode lead and data lines are arranged on an identical layer in insulated way. Each touch electrode is corresponding to at least one touch electrode lead. Each pixel unit is corresponding to one touch electrode lead. The touch electrode lead is arranged between two pixel units and adjacent to a blue sub-pixel unit.

The specific embodiments of the present disclosure provide a liquid crystal display device having a touch sensor in order to improve the transmittance of the touch display panel. The liquid crystal display device comprises an array substrate and a color filter substrate which are arranged oppositely. The array substrate comprises multiple pixel units which are arranged in an array. Each pixel unit comprises a red sub-pixel, a green sub-pixel and a blue sub-pixel. The function of touch control is implemented through a touch lead, and a common electrode covering a data line between a blue sub-pixel and a red sub-pixel of two adjacent pixel units are set as the touch lead.

The specific embodiments of the present disclosure provide a liquid crystal display device having a touch sensor. Common electrodes each covering a data line between a blue sub-pixel and a red sub-pixel of two adjacent pixels are set as touch leads, and common electrodes of two adjacent rows of pixels which are subjected to multiplexing as the touch leads are interconnected, and the rest common electrodes are not interconnected. Moreover, the common electrodes subjected to multiplexing as the touch leads each have a width wider than the rest common electrodes.

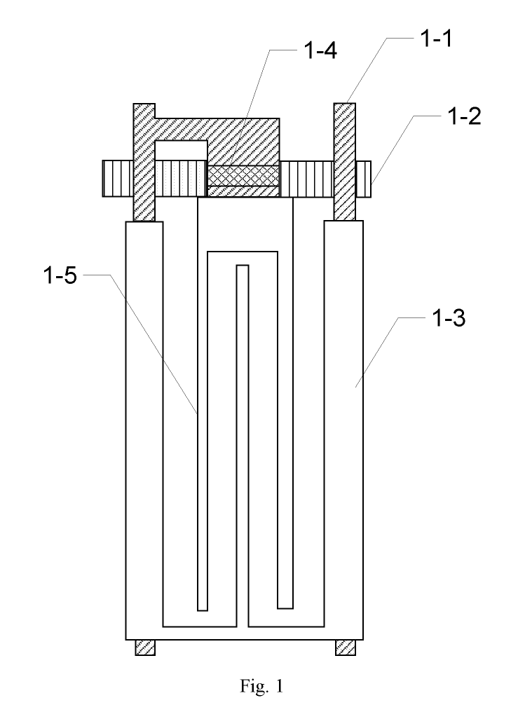

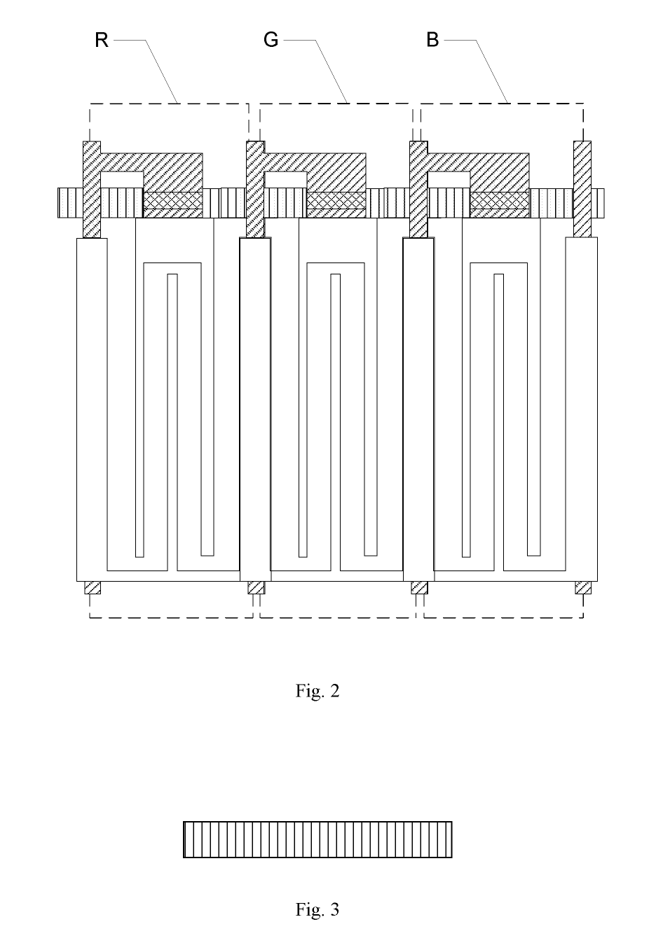

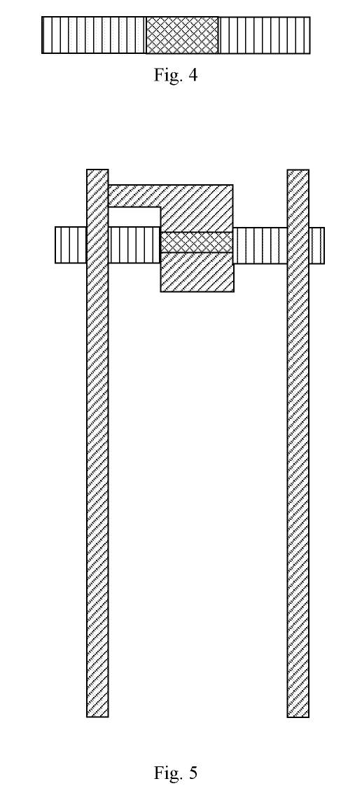

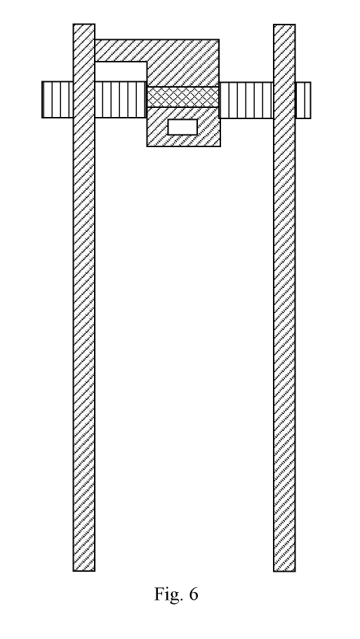

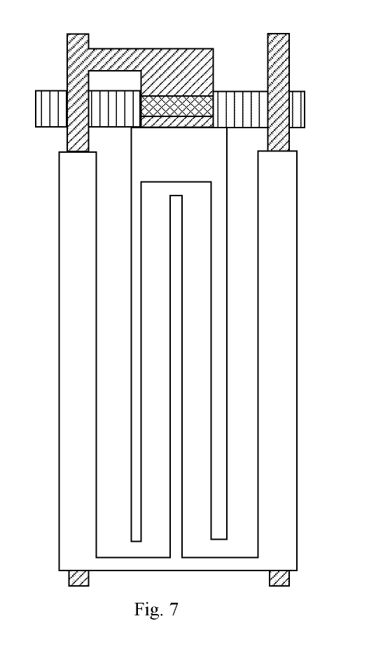

As for FIG. 1 and FIG. 2, FIG. 1 shows a sub-pixel structure in the prior art, and FIG. 2 shows a pixel structure with the sub-pixel structure in FIG. 1. Further, FIGS. 3 to 7 each show a structure diagram of a layer of the pixel structure of FIG. 2.

In display and touch stages of the touch display panel, the signal loaded on the Tx lead is always consistent with the signal of the common electrode. Therefore, in the embodiments of the present disclosure, the touch electrode lead is subjected to multiplexing as the common electrode line, which renders it unnecessary to provide a common electrode additionally beside the touch electrode lead like in the prior art. This can reduce the decrease of transmittance of the pixel due to introduction of the touch electrode lead.

The following further introduces the touch display panel having the touch sensor provided in the embodiments of the present disclosure in connection with the accompanying drawings.

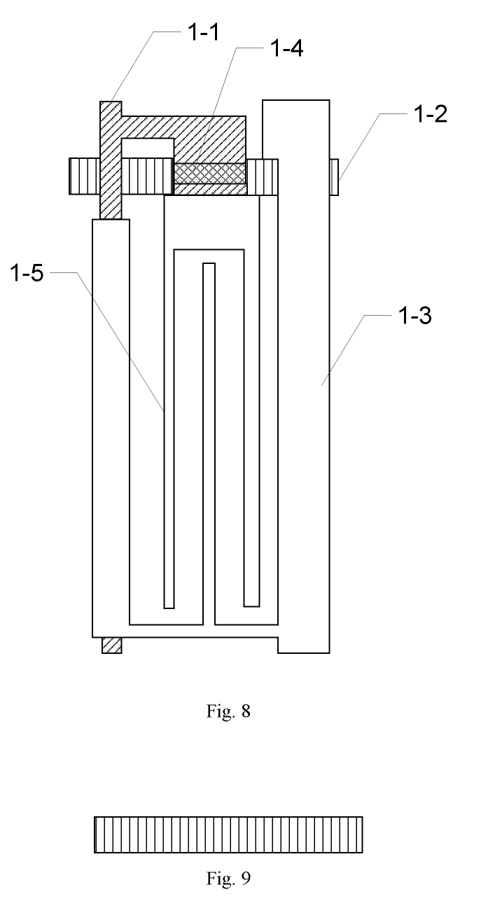

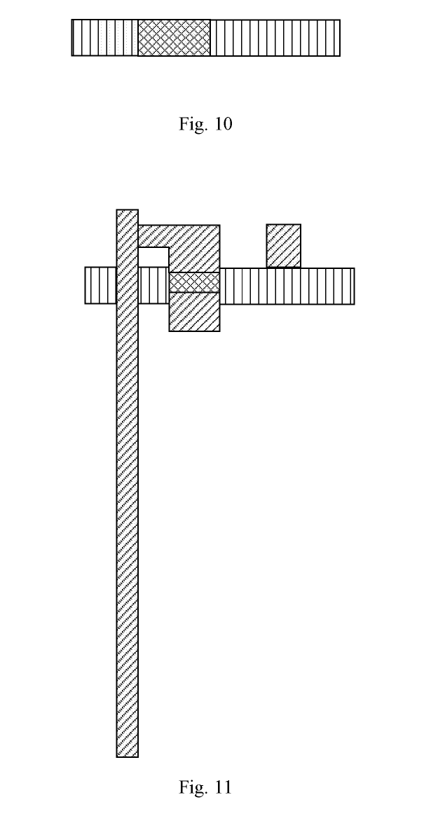

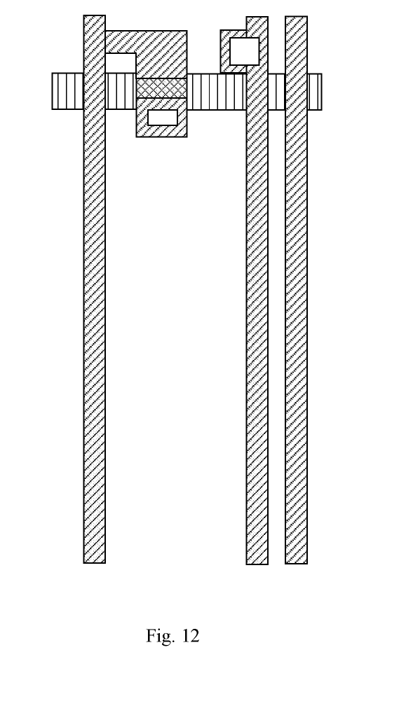

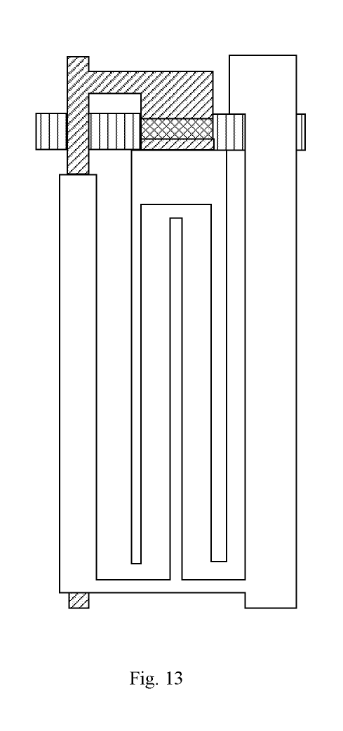

In the present disclosure, each pixel comprises two kinds of sub-pixels, wherein the first kind of sub-pixel is the same as a traditional pixel, for example, an R sub-pixel used for a red color resistor and a G sub-pixel used for a green color resistor as shown in FIG. 1. The second kind of sub-pixel is provided therein with a touch lead which, as shown in FIG. 8, serves as a touch line during touch scanning and serves as a common electrode during the rest of the time. The second kind of sub-pixel is a B sub-pixel used for a blue color resistor. The touch lead is placed in the B sub-pixel of the blue color resistor, which would not lead to significant decrease of the penetration rate of the display. FIGS. 9 to 13 each show a structural diagram of a layer of the second kind of sub-pixel.

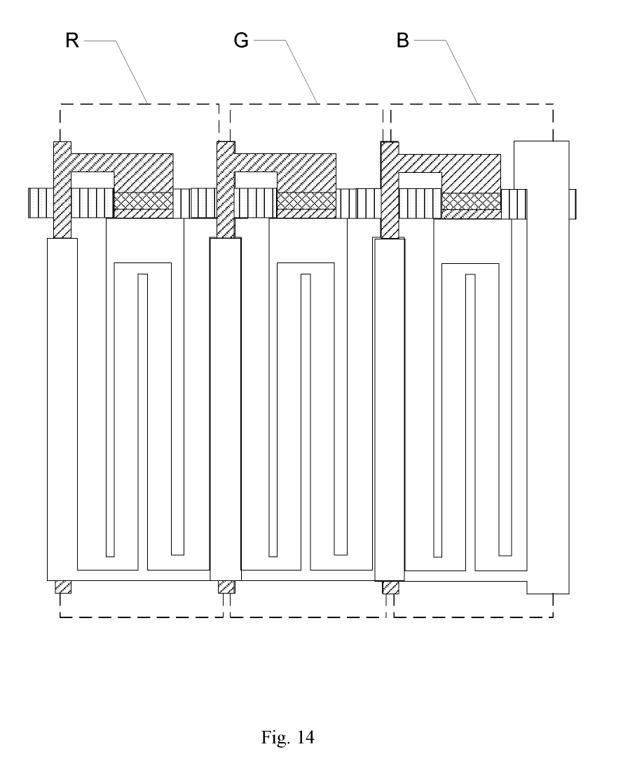

FIG. 14 shows a diagram of a structure of an entire pixel. The pixel comprises two kinds of sub-pixels, wherein an R pixel and a G pixel each are composed of the first kind of sub-pixels, and a B pixel is composed of the second kind of sub-pixels.

A pixel array structure is formed by periodically arranging a plurality of the pixels as shown in FIG. 14. Moreover, multiple sensors are arranged in the touch display device and each of the sensors is a pixel array.

The liquid crystal display device having the touch sensor according to the present disclosure is characterized in that the liquid crystal display device comprises an array substrate and a color filter substrate which are arranged oppositely. The array substrate comprises multiple pixel units which are arranged in an array. Each pixel unit comprises a red sub-pixel, a green sub-pixel and a blue sub-pixel. The function of touch control is achieved through the touch lead. The common electrodes covering the data lines between the blue sub-pixels and the red sub-pixels of two adjacent pixel units are set as the touch leads. The touch lead serves as the touch line during a touch scanning stage and serves as the common electrode during a non-touch scanning stage. Moreover, the common electrodes of two adjacent rows of pixels that are subjected to multiplexing as the touch leads are interconnected.

A method of driving a liquid crystal display device having a touch sensor comprises the following stages. In a touch scanning stage, a touch drive signal is loaded to a touch electrode through a touch lead. The touch electrode is configured to output a sensing signal, and the touch electrode is connected with the touch signal detection module which confirms a touch position in accordance with the sensing signal output by the touch electrode. In a non-touch scanning stage, namely a display state, a common electrode signal is loaded to the touch electrode through the touch lead.

The present disclosure is described above with reference to specific embodiments, but it should be noted that these embodiments are merely exemplary of the principles and applications of the present disclosure. It should therefore be understood that the exemplary embodiments can be amended in various ways and other designs can also be provided without departure from the spirit and scope of the present disclosure. One should also understand that different features in the dependent claims and the description can be combined in ways different from those described in the original claims, and that a combination of features in one embodiment can be used in other embodiments.

1. A liquid crystal display device having a touch sensor, wherein data lines covering pixels serve as touch leads.

2. The liquid crystal display device having a touch sensor according to claim 1, wherein the liquid crystal display device comprises an array substrate and a color filter substrate which are arranged oppositely, wherein the array substrate comprises a plurality of pixel units which are arranged in an array, wherein each of the pixel units comprises a red sub-pixel, a green sub-pixel, and a blue sub-pixel, and a common electrode covering a data line between the blue sub-pixel and the red sub-pixel of two adjacent pixel units are set as the touch lead.

3. The liquid crystal display device having a touch sensor according to claim 2, wherein the touch lead serves as a touch line during a touch scanning stage and serves as the common electrode during a non-touch scanning stage.

4. The liquid crystal display device having a touch sensor according to claim 2, wherein the common electrodes of two adjacent rows of pixels that are subjected to multiplexing as the touch leads are interconnected.

5. The liquid crystal display device having a touch sensor according to claim 3, wherein the common electrodes subjected to multiplexing as the touch leads are wider than the rest common electrodes.

6. The liquid crystal display device having a touch sensor according to claim 3, wherein the common electrodes are presented as strips.

7. The liquid crystal display device having a touch sensor according to claim 3, wherein the array substrate comprises a plurality of data lines arranged in parallel, wherein the touch leads and the data lines are arranged on a same layer in insulated way, and each touch electrode is corresponding to at least one touch lead.

8. The liquid crystal display device having a touch sensor according to claim 3, wherein the common electrodes of two adjacent rows of pixels are subjected to multiplexing as the touch leads and are interconnected.

9. The liquid crystal display device having a touch sensor according to claim 2, wherein the array substrate comprises a plurality of data lines arranged in parallel, wherein the touch leads and the data lines are arranged on a same layer in insulated way, and each touch electrode is corresponding to at least one touch lead.

10. A method of driving a liquid crystal display device having a touch sensor, wherein the driving method comprises:
a touch scanning stage, during which a touch drive signal is loaded to a touch electrode through a touch lead, wherein the touch electrode is configured to output a sensing signal, and the touch electrode is connected with a touch signal detection module which confirms a touch position in accordance with the sensing signal output by the touch electrode, and
a non-touch scanning stage, during which a common electrode signal is loaded to the touch electrode through the touch lead to achieve liquid crystal display.
